(19) United States
(12) Patent Application Publication
(10) Pub. No.: US 2013/0244043 A1
(43) Pub. Date: Sep. 19, 2013

(54) ADDUCTS OF ISOCYANATOALKYLTRIALKOXYSILANES AND ALIPHATIC, ALKYL-BRANCHED DIOLS OR POLYOLS

(71) Applicants: Rainer LOMOELDER, Muenster (DE); Andre RAUKAMP, Marl (DE); Sabine NAUMANN, Herne (DE); Christoph NACKE, Schermbeck (DE); Silvia HERDA, Herne (DE)

(72) Inventors: Rainer LOMOELDER, Muenster (DE); Andre RAUKAMP, Marl (DE); Sabine NAUMANN, Herne (DE); Christoph NACKE, Schermbeck (DE); Silvia HERDA, Herne (DE)

(73) Assignee: Evonik Degussa GmbH, Essen (DE)

(21) Appl. No.: 13/799,626

(22) Filed: Mar. 13, 2013

(30) Foreign Application Priority Data
Mar. 19, 2012 (DE) 10 2012 204 290.3

(51) Int. Cl. C09D 7/12

(52) U.S. Cl. CPC C09D 7/1233
USPC 428/429; 524/188; 556/414; 428/447

(57) ABSTRACT

Low molecular mass adduct compositions of isocyanatoalkyltrialkoxysilanes and aliphatic alkyl-branched diols or polyols are provided. The adduct compositions are liquid at temperatures of greater than 0° C. Coating compositions which provide scratch resistant clearcoat coatings upon curing are also provided.

### CROSS REFERENCE TO RELATED APPLICATIONS

This application claims priority to German Application No. 102012204290.3, filed Mar. 19, 2012, the disclosure of which is incorporated by reference in its entirety.

### BACKGROUND OF THE INVENTION

The present invention relates to low molecular mass adducts of isocyanatealkyl-trialkoxysilanes and aliphatic alkyl-branched diols or polyols, which are preferably liquid at temperatures of greater than 0° C., and to the coating materials produced from them, especially scratch-resistant clearcoats.

Modern coatings of all kinds, especially finishes in the automotive sector, are subject to exacting requirements in terms of scratch resistances. Numerous approaches have been made in the past to obtain the highest scratch resistance of topcoats via combinations of polyurethane (PU) crosslinking and silane crosslinking (WO 2008/074489A1, WO 2008/110229A3, WO 2006/042658A, WO 2008/110230A, EP1273640A, DE 102004050747). Isocyanate-free systems are known and have been described (EP 1802716B1, WO 2008/131715A1, WO 2008/034409). Generally speaking, the scratch resistance is dependent on the crosslinking density, in other words on the amount of silane monomers or —Si(OR)₃— groups. Relatively low solids content in the coating formulations, which may be attributed to the relatively high molecular weights of the silane-functional crosslinkers, is a disadvantage of these technologies.

Low molecular mass adducts of diols and isocyanatopropyltrialkoxysilanes may be suitable for achieving very high amounts of —Si(OR)₃ groups as described in WO 2008/034409 or WO 2008/131715. However, a problem often associated with such conventionally known systems is inadequate flexibility of the resultant coatings. A further problem is the high crystallization tendency and low compatibility of adducts of isocyanatopropyltrialkoxysilanes and low molecular mass diols, such that, at curing temperatures of below 100° C., there is a likelihood of levelling problems and surface defects in the resultant coating film as a result of crystallization-associated incompatibilities between the coating components.

In the conventional systems described above, for the automotive sector, the clearcoats are heat-cured at temperatures above 100° C.

It is an object of the present invention to provide improved starting materials which are suitable for producing scratch-resistant coatings, more particularly high-gloss, scratch-resistant clearcoats. A further aim is to ensure sufficient flexibility in the coatings obtained, while retaining the stated profile of properties over a broad temperature range for application and curing of the liquid coatings, especially at temperatures in the range below 100° C.

### SUMMARY OF THE INVENTION

These and other objects have been achieved by the present invention, the first embodiment of which includes an adduct composition, comprising:

an adduct obtained by reaction of a compound of formula (I):

OCN-(Alkyl)-Si(Alkoxy)₃ (I)

with compounds of the formula (II):

HO—(R)—OH (II)

wherein (Alkyl) is a linear or branched alkylene chain having 1-4 carbon atoms, (Alkoxy) each independently is ethoxy, propoxy or butoxy group, and R is a branched alkylene or cycloalkylene radical having not more than 20 carbon atoms, optionally substituted with one or more hydroxy-groups. In one preferred embodiment the adduct obtained by reaction of a compound of formula (I): OCN-(Alkyl)-Si(Alkoxy)₃ with compounds of the formula (II): HO—(R)—OH is a liquid at a temperature greater than 0° C.

In another embodiment, the present invention provides a coating composition containing the adduct composition and further containing: B) one or more binder components, C) optionally, a catalyst, D) optionally, an auxiliary or additive, and E) optionally an organic solvent. Additionally, coatings obtained by curing the composition, especially clearcoat coatings are included in the present invention.

### DETAILED DESCRIPTION OF THE INVENTION

In a first embodiment the present invention provides an adduct composition, comprising:

an adduct obtained by reaction of a compound of formula (I):

OCN-(Alkyl)-Si(Alkoxy)₃ (I)

with compounds of the formula (II):

HO—(R)—OH (II)

wherein (Alkyl) is a linear or branched alkylene chain having 1-4 carbon atoms, (Alkoxy) each independently is ethoxy, propoxy or butoxy group, and R is a branched alkylene or cycloalkylene radical having not more than 20 carbon atoms, optionally substituted with one or more hydroxy-groups. The adduct obtained by reaction of a compound of formula (I): OCN-(Alkyl)-Si(Alkoxy)₃ with compounds of the formula (II): HO—(R)—OH may preferably be a liquid at a temperature greater than 0° C.

The low molecular mass adducts of isocyanatoalkyltrialkoxysilanes and aliphatic branched diols or polyols, which are preferably liquid at temperatures above 0° C. may be cured over a wide temperature range leading to surprisingly scratch-resistant coatings featuring outstanding levelling and gloss.

Preferably R may be a branched alkylene or cycloalkylene radical having from 2 to 20, carbon atoms, and R may optionally be hydroxy-substituted. Preferably, a ratio of OH groups from compound (II) to NCO groups from compound (I) may be from 0.8:1 to 1.2:1, more preferably 0.9:1 to 1.1:1, with stoichiometric reaction being especially preferred. With particular preference, therefore, there is complete reaction of all of the OH groups of the compounds of the formula (II) with NCO groups of the compounds of the formula I.

In the adduct formation reaction, the NCO groups of the compounds of the formula (I) react with the OH groups of the compounds of the formula (II) to form —NH—CO—O— groups, which link the compounds of the formulae (I) and (II) to one another.

Suitable compounds of the formula (I) OCN-(Alkyl)-Si(Alkoxy)₃ include in principle all of the possible compounds described above. With particular preference, (Alkoxy)₃ is selected from trimethoxy and triethoxy groups.

Examples of suitable compounds of the formula (I) include isocyanatoalkylalkoxysilanes which more particularly are selected from the group consisting of 3-isocyanatopropyltrimethoxysilane, 3-isocyanatopropyltriethoxysilane, 3-isocyanatopropyltriisopropoxysilane, 2-isocyanatoethyltrimethoxysilane, 2-isocyanatoethyltriethoxysilane, 2-isocyanatoethyltriisopropoxysilane, 4-isocyanatobutyltrimethoxysilane, 4-isocyanatobutyltriethoxysilane, 4-isocyanatobutyltriisopropoxysilane, isocyanatomethyltrimethoxysilane, isocyanatomethyltriethoxysilane and/or isocyanatomethylriisopropoxysilane.

Particular preference may be given to using 3-isocyanatopropyltrialkoxysilanes, more particularly 3-isocyanatopropyltrimethoxysilane and/or isocyanatopropyltriethoxysilane as compounds of the formula (I).

Suitable compounds of the formula (II) HO—(R)—OH in which R is a branched alkylene or cycloalkylene radical having not more than 20, in particular 2 to 20, carbon atoms, wherein R may optionally be hydroxy-substituted, include aliphatic branched diols or polyols. The compounds of the formula (II) preferably have a molecular weight of 76 to 314 g/mol, more preferably of 90 to 206 g/mol. These ranges include all ranges and subranges therein.

The compounds of the formula (II) are preferably selected from the group consisting of 2,2,4-trimethylhexane-1,6-diol and 2,4,4-trimethylhexane-1,6-diol alone or as any desired mixtures of these isomers, 2,2-dimethylbutane-1,3-diol, 2-methylpentane-2,4-diol, 3-methylpentane-2,4-diol, 2,2,4-trimethylpentane-1,3-diol, 2-ethylhexane-1,3-diol, 2,2-dimethylhexane-1,3-diol, 3-methylpentane-1,5-diol, 2-methylpentane-1,5-diol, 2,2-dimethylpropane-1,3-diol (neopentyl glycol), neopentyl glycol hydroxypivalate, 1,1,1-trimethylolpropane, 3(4),8(9)-bis(hydroxymethyl)tricyclo[5.2.1.02,6]decane (Dicidol) and/or 2,2-bis(4-hydroxycyclohexyl)propane. Particular preference is given to using 1,1,1-trimethylolpropane, 3-methylpentane-1,5-diol, neopentyl glycol, 2,2,4-trimethylhexane-1,6-diol and 2,4,4-trimethylhexane-1,6-diol, alone or as any desired mixtures of these isomers, and/or neopentyl glycol hydroxypivalate. The stated compounds may each be used alone or in the form of mixtures thereof. It is especially preferred to use 2,2,4-trimethylhexane-1,6-diol and 2,4,4-trimethylhexane-1,6-diol, alone or as any desired mixtures of these isomers.

The compounds of the formula (II) that are used may also, additionally, contain up to a fraction of 40% by weight of further diols and/or polyols. These diols and/or polyols may be selected from compounds of low molecular mass and/or from hydroxyl-containing polymers.

Examples of suitable low molecular mass compounds include ethylene glycol, 1,2- and 1,3-propanediol, diethylene, dipropylene, triethylene and tetraethylene glycol, 1,2- and 1,4-butanediol, 1,3-butylethylpropanediol, 1,3-methylpropanediol, 1,5-pentanediol, bis(1,4-hydroxymethyl)cyclohexane (cyclohexanedimethanol), glycerol, hexanediol, hexane-1,2,6-triol, butane-1,2,4-triol, tris(β-hydroxyethyl)isocyanurate, mannitol, sorbitol, polypropylene glycols, polybutylene glycols, xylylene glycol or hydroxyacrylates, alone or as mixtures.

Suitable additional polyols may include hydroxyl-containing polymers such as, polyesters, polyethers, polyacrylates, polycarbonates and polyurethanes having an OH number of 20 to 500 mg KOH/gram and an average molar mass of 250 to 6000 g/mol. Particular preference may be given to using hydroxyl-containing polyester and/or polyacrylates having an OH number of 20 to 150 mg KOH/gram and an average molecular weight of 500 to 6000 g/mol.

The hydroxyl number (OHN) is determined in accordance with DIN 53240-2.

In the method according to DIN 53240-2, the sample is reacted with acetic anhydride in the presence of 4-dimethylaminopyridine as catalyst, the hydroxyl groups being acetylated. Thus for each hydroxyl group, one molecule of acetic acid is formed, and the subsequent hydrolysis of the excess acetic anhydride supplies two molecules of acetic acid. The consumption of acetic acid is determined by titrometry from the difference between the main value and a blank value, which must be carried out in parallel.

Furthermore, mixtures of the abovementioned polymers may also be used as additional polyols.

The adducts of the invention may be prepared in the absence of a solvent or using non-protic solvents, and the reaction may take place continuously or batchwise. The reaction may be conducted at temperatures in the range of 20-25° C., but it may be preferred to use higher temperatures in the range of 30-150° C., more particularly in the range of 50-150° C. To accelerate the reaction, catalysts that are known in urethane chemistry may be employed. Examples of conventionally known catalysts include Sn carboxylates, Bi carboxylates, Zn carboxylates and other metal carboxylates, tertiary amines such as, for example, 1,4-diazabicyclo[2.2.2]octane (DABCO), triethylamine, etc. The reaction may preferably be conducted in the absence of water.

Being non-crystallizing compounds of low molecular mass the adducts of the invention are liquid at temperatures of more than 0° C. Depending on the selected stoichiometry of the two reactants, the adduct composition may contain free hydroxyl or isocyanate groups. On the basis of the preferred embodiment, the adducts of the invention are substantially free from hydroxyl groups. In solvent-free form, the adduct composition of the invention may be of low to medium viscosity and liquid at 0° C. For better handling, however, the products may also be admixed with solvents, which like alcohols may also be protic. The solids contents of such compositions are preferably greater than 80% by weight and preferably have a maximum viscosity of 500 mPas (DIN EN/ISO 3219 23° C.).

The adduct composition of the invention of isocyanatoalkyltrialkoxysilane and branched diols or polyols may be used advantageously as a crosslinking component for scratch-resistant clearcoats. When employed for a clearcoat, for the purpose of optimizing the mechanical qualities of the coating, the adduct compositions may be blended with polymeric binders, which may also carry crosslinkable functional groups. As the reactivity of the silane adducts of the invention may not be sufficient for a curing rate at ambient temperature, the crosslinking rate may be increased by addition of catalysts.

Suitable crosslinking catalysts include metal chelates or transition-metal chelates, salts thereof or particles thereof, including titanium complexes, aluminium complexes, tin complexes or zirconium complexes, sulfonic acids, phosphoric acid or phosphorous acids and derivatives thereof, carboxylic acids having melting points of more than 60° C., quaternary ammonium carboxylates, or else combinations thereof. The coating compositions in accordance with the invention may be solvent-free or solvent-containing; with particular preference, the coating materials may be non-aqueous. Non-aqueous according to the present invention includes a water content in the coating composition of not more than 1.0% by weight, preferably not more than 0.5% by weight, based on the coating composition. In two-component formulations in particular, the aforementioned small amount of water may be used to accelerate curing. With particular preference, the coating system used may be free of water.

The coating compositions may crosslink even at temperatures below 100° C. and may be used in particular for application to wood, plastic, glass or metal to obtain highly scratch-resistant coatings.

The invention accordingly further provides for the use of adduct compositions from the reaction of compounds of the formula (I)

OCN-(Alkyl)-Si(Alkoxy)₃ (I)

with compounds of the formula (II)

HO—(R)—OH (II)

in which Alkyl denotes linear or branched alkylene chains having 1-4 carbon atoms, Alkoxy, simultaneously or independently at each occurrence, denotes methoxy, ethoxy, propoxy or butoxy groups, and R denotes a branched alkylene or cycloalkylene radical having not more than 20, more particularly 2 to 20, carbon atoms, and R can be hydroxy-substituted, as coating compositions or as a constituent of coating compositions, more particularly for producing scratch-resistant clearcoats.

The coatings obtained on the basis of the coating compositions according to the present invention are characterized by a high level of resistance towards mechanical stress, and in particular they have a high scratch resistance. Surprisingly, the coatings also have a high flexibility and high gloss.

The present invention further provides coating compositions, which are preferably curable at temperatures of 20 to 100° C., comprising

A) adducts in accordance with the present invention from the reaction of compounds of the formula (I)

OCN-(Alkyl)-Si(Alkoxy)₃ (I)

with compounds of the formula (II)

HO—(R)—OH (II)

in which Alkyl denotes linear or branched alkylene chains having 1-4 carbon atoms, Alkoxy, simultaneously or independently at each occurrence, denotes methoxy, ethoxy, propoxy or butoxy groups, and R denotes a branched alkylene or cycloalkylene radical having not more than 20, more particularly 2 to 20, carbon atoms, and R can be hydroxy-substituted,

B) one or more binder components,

C) optionally up to 4% by weight of at least one catalyst,

D) optionally auxiliaries and additives,

E) optionally organic solvents.

The fraction of the adduct composition of the invention as component A) in the coating composition of the invention may be 20-90% by weight, preferably 30% to 80% by weight, based on the coating composition.

Furthermore, the coating composition of the invention may optionally comprise one or more binder components. Suitable binder components are in principle all of the kinds of binders known to the skilled person, including, for example, thermoplastic binders, i.e. uncrosslinkable binders, which typically have an average molecular weight of greater than 10 000 g/mol. It may be preferred, however, to use binders which comprise reactive functional groups having acidic hydrogen atoms. Suitable binders having acidic hydrogen atoms may have at least one, preferably two or more hydroxyl group(s). Examples of other suitable functional groups in the binder include trialkoxysilane functionalities.

As binders with functional groups, preferred hydroxyl-containing polymers, including hydroxyl-containing polyesters, hydroxyl-containing polyethers, hydroxyl-containing polyacrylates, hydroxyl-containing polycarbonates and hydroxyl-containing polyurethanes, wherein an OH number of the polymer is from 20 to 500 mg KOH/g and an average molar mass is from 250 to 6000 g/mol. Particularly preferred binder components may be hydroxyl-containing polyesters or polyacrylates having an OH number of 20 to 150 mg KOH/g and an average molecular weight of 500 to 6000 g/mol.

The hydroxyl number (OHN) is determined in accordance with DIN 53240-2.

In this method, the sample is reacted with acetic anhydride in the presence of 4-dimethylaminopyridine as catalyst, the hydroxyl groups being acetylated. For each hydroxyl group, one molecule of acetic acid is obtained, while the subsequent hydrolysis of the excess acetic anhydride supplies two molecules of acetic acid. The consumption of acetic acid is determined by titrometry from the difference between the main value and a blank value, which must be conducted in parallel. The molecular weight is determined by gel permeation chromatography (GPC). The samples may be characterized in tetrahydrofuran as eluent in accordance with DIN 55672-1.

As hydroxyl-containing (meth)acrylic copolymers, resins having a monomer composition described in WO 93/15849 (page 8, line 25 to page 10, line 5), or else in DE 195 29124 may be preferred. The acid number may be set in the (meth)acrylic copolymer through proportional use of (meth)acrylic acid as monomer and may be 0-30, preferably 3-15 mg KOH/g. The number-average molar weight (determined by gel permeation chromatography against a polystyrene standard) of the (meth)acrylic copolymer may preferably be from 2000-20 000 g/mol; the glass transition temperature may preferably be from −40° C. to +60° C. The hydroxyl content of the (meth)acrylic copolymers in accordance with the present invention may preferably be from 70-250 mg KOH/g, more preferably 90-190 mg KOH/g.

Polyester polyols suitable in accordance with the invention include resins having a monomer composition of dicarboxylic and polycarboxylic acids and diols and polyols, as described, for example, in Stoye/Freitag, Lackharze [Resins for coatings], C. Hanser Verlag, 1996, page 49 or else in WO 93/15849. As polyester polyols, polyadducts of caprolactone with low molecular mass diols and triols, available for example under the name CAPA (Perstorp) may be employed. The arithmetically ascertained number-average molar weight of these polyols may preferably be 500-5000 g/mol, more preferably 800-3000 g/mol; the average functionality may preferably be 2.0-4.0, more preferably 2.0-3.5.

Among the urethane and ester group-containing polyols for use in accordance with the invention may include the polyols described in EP 140 186. Urethane and ester group-containing polyols prepared using HDI, IPDI, trimethylhexamethylene diisocyanate (TMDI) or (H₁₂-MDI) may be preferred. The number-average molar weight of these polyols may preferably be from 500-2000 g/mol; the average functionality may be from 2.0-3.5.

Trialkoxysilane-functional binders may also be suitable for use as component B. Such resins may be obtained by copolymerization of acrylate or methacrylate monomers with acryloyl- or methacryloyl-functional alkyl-trialkoxysilane derivatives (e.g. Dynasylan® MEMO from Evonik Industries AG), as described in WO 92/11328. An alternative synthesis pathway is the derivatization of hydroxyl-containing polyethers, polyesters, polycarbonate diols or polyacrylates with isocyanatopropyltrialkoxysilane, as described in Examples 3 and 4 of WO 2008/131715.

Mixtures of the above-described binders may be employed. Preferred binders include hydroxyl-containing polyesters and polyacrylates, alone or in mixtures.

The content of B) in the coating composition of the invention is 10-80% by weight, based on the coating composition, more preferably 20% to 80% by weight.

The mass ratio of component A) to component B) in the coating composition of the invention may preferably be from 3:7 to 7:3.

To achieve a sufficient curing rate at curing temperatures of less than 100° C., catalysts C) may be included in the composition. Suitable catalysts include Lewis acids, metal chelates or transition-metal chelates, salts thereof or particles thereof, based for example on titanium complexes, aluminium complexes, tin complexes or zirconium complexes, sulfonic acids in free or else neutralized or adducted form, as described in DE 2356768, phosphoric acid or phosphorous acids and their derivatives (WO 2008/074491, page 18, lines 1-17), high-boiling acids, quaternary ammonium carboxylates. Combinations of catalysts may be used. Preferably, transition-metal chelates or their salts, high-boiling acids, quaternary ammonium carboxylates, or combinations thereof may be employed.

In a preferred embodiment of the present invention, component C) comprises C1) at least one organic carboxylic acid having a melting point of more than 60° C. and/or C2) at least one tetraalkylammonium carboxylate.

Suitable organic carboxylic acids having a melting point of more than 60° C. (under atmospheric pressure) are compounds which are non-volatile at room temperature. Examples of carboxylic acids for advantageous use include salicylic acid, benzoic acid, citric acid, isophthalic acid, phthalic acid, terephthalic acid and/or trimellitic acid. According to the present invention, salicylic acid and benzoic acid are highly preferred as C1).

Catalyst C2) may be a tetraalkylammonium carboxylate. Examples thereof include tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and/or tetrabutylammonium benzoate. Mixtures of any of these may be employed. Highly preferred C2) catalysts include tetraethylammonium benzoate and tetrabutylammonium benzoate as well as mixtures thereof.

The catalyst component C) in the coating materials of the invention may consist solely of the aforementioned alternatives C1) or C2), but it is also possible to use any desired mixtures of the catalysts C1) and C2). When a mixture is employed a mass ratio of C1) to C2) may be from 9:1 to 1:9 (m/m).

The fraction of component C) may preferably be up to 4% by weight, based on the coating composition, preferably 0.1% to 4% by weight.

The coating composition of the invention may further comprise conventionally employed amounts of auxiliaries and/or additives D) including stabilizers, light stabilizers, catalysts, fillers, pigments, levelling agents or rheological assistants, such as sag control agents, for example microgels or fumed silica. Component D) may also include organic or inorganic colour and/or effect pigments conventionally known to one of ordinary skill in coatings technology.

In the case of pigment-free coating compositions, i.e. clearcoats, component D) is present preferably in amounts of 0.5% up to 8% by weight, more particularly 1% to 6%, based on the coating composition. In the case of pigment and/or filler-containing materials, the amount of component D) may be 5% to 80% by weight, more particularly 10% to 70% by weight, based on the coating composition.

The coating composition of the invention may further comprise organic solvents as component E). Examples of suitable solvents include ketones, esters, alcohols or aromatics.

The content of component E) in the coating composition of the invention preferably may be from 20% to 60% by weight, more particularly 20% to 50%, based on the coating composition. The amount of component E) may be determined by the application viscosity required for the coating composition.

The sum total of all of the fractions of components A) to E) makes 100% by weight. The coating composition of the invention may preferably consist of components A) to E).

The coating composition of the invention are produced by mixing appropriate components A) to E) depending on the selected final formulation. Mixing may take place in mixers known to the skilled person, examples being stirred vessels, dissolvers, bead mills, roll mills, etc., or else continuously by means of static mixers.

The present invention likewise provides metal-coating compositions, more particularly for vehicle bodies, cycles and motorcycles, building components and household appliances, which comprise the adduct composition or coating composition of the invention.

Coating compositions for glass coatings, plastics coatings, or wood coatings, more particularly clearcoats, comprising the adduct composition or coating composition of the invention are likewise provided for the present invention.

The coating materials of the invention may also be suitable for multi-coat finishing, such as for clearcoat in automotive OEM finishing.

Having generally described the invention, a further understanding can be obtained by reference to certain specific examples which are provided herein for purposes of illustration only, and are not intended to be limiting unless otherwise specified.

The present invention is described in more detail in the following examples.

### EXAMPLES

Unless otherwise indicated, the quantities in percent in the examples are given by weight.

### Example 1

### Preparation of the Adducts of the Invention

27.4 g of an isomer mixture (about 50/50) of 2,2,4- and 2,4,4-trimethylhexanediol were introduced into a 250 ml 3-necked flask and 0.2 g of dibutyltin dilaurate (DBTDL) added with stirring. Under a steady stream of nitrogen, the mixture was heated to 60° C. in a water bath. Subsequently, with stirring, 72.4 g of 3-isocyanatopropyltrimethoxysilane was added dropwise at a rate such that the temperature did not climb above 70° C. Following complete addition, the reaction mixture was stirred at 60° C. for 6 hours. The free NCO content was less than 0.1%. The product was a clear liquid of medium viscosity.

The amounts of the raw materials used in the further experiments are indicated in Table 1. Example 2 was not in accordance with the invention. The comparative example, using 1,12-dodecanediol, exhibits a pronounced crystallization tendency.

TABLE 1
Formulas of the examples and physicochemical characteristics of the products

| | | Example 1 | Example 2 | | |
|---|---|---|---|---|---|
| | | (inventive) | (not inventive) | Example 3 | Example 4 |
| | | IPMS: TMH- | IPMS: 1,12- | (inventive) | (inventive) |
| | | diol | dodecanediol | IPMS: HPN | IPMS: NPG |
| NCO:OH ratio | | 1.0:1.0 | 1.0:1.0 | 1.0:1.0 | 1.0:1.0 |
| Isocyanato- | | 72.4 g | 67.6 g | 67.2 g | 80.1 g |
| propyl- | | | | | |
| Trimethoxysilane | | | | | |
| TMH-diol | | 27.4 g | — | — | ' |
| 1,12-dodecanediol | | — | 32.4 g | — | — |
| HPN | | — | — | 32.6 g | — |
| NPG | | — | — | — | 19.7 g |
| DBTDL | | 0.2 g | 0.2 g | 0.2 g | 0.2 g |
| Characteristics | | | | | |
| NCO content DIN | % | <0.1 | | <0.1 | <0.1 |
| EN/ISO 11909 | | | | | |
| Viscosity at | mPas | 543 | | 956 | 575 |
| 23° C. DIN | | | | | |
| EN/ISO 3219 | | | | | |
| Colour No. DIN | Haze | 54 | | 19 | 12 |
| EN/ISO 6271 | | | | | |
| Haze DIN | FNU | 1.11 | | 1.70 | 0.90 |
| EN/ISO 7027 | | | | | |
| Remark | | Remains liquid | Adduct is | Remains liquid | Remains liquid |
| | | after 4-week | crystalline | after 4-week | after 4-week |
| | | storage at 5° C. | solid | storage at 5° C. | storage at 5° C. |

TMH-diol=2,2,4- and 2,4,4-trimethylhexanediol, HPN=neopentyl glycol hydroxypivalate, NPG=neopentyl glycol (2,2-dimethylpropane-1,3-diol), DBTL=dibutyltin dilaurate

### Example 2

### Coating Formulations in Accordance with the Present Invention

Coating Formulation

47.45% by weight Setalux 1767 (polyacrylate polyol, Nuplex Resins B.V., solids content 65% in solvent naphtha)

30.8% by weight IPMS adduct (as per example in Table 1)

0.3% by weight TEAB (tetraethylammonium benzoate, catalyst, Aldrich)

10.4% by weight butyl acetate

10.4% by weight xylene

0.05% by weight TEGO® Glide 410 (polyetherpolysiloxane copolymer, Evonik Industries AG)

0.3% by weight Tinuvin® 292 (HALS stabilizer, BASF S.E.)

0.3% by weight Tinuvin® 900 (UV absorber, BASF S.E.)

The clearcoats were produced by mixing the stated components in a closed stirring vessel at room temperature.

The formulated coatings possessed spray viscosity (about 20 sec. DIN 4). They were applied in spray application to phosphated steel panels (Gardobond 26S 60 OC, manufacturer: Chemetall, D) and were cured either at room temperature or for 30 minutes at 60° C. in a forced-air oven. The dry film coat thickness was 30-40 μm.

When using the inventive products, the resultant coatings were of high gloss, free from surface coverings, and resistant to chemicals and scratching. In the case of the non-inventive product from Example 2, RT curing results in a matt surface as a result of formation of a covering. The results obtained are summarized in Table 2.

TABLE 2
Properties of the coatings

| | Base diol | | | | | | | |
|---|---|---|---|---|---|---|---|---|
| | Dodecane diol | | TMH-diol | | NPG | | HPN | |
| | Curing | | | | | | | |
| | | 30 min, | | 30 min, | | 30 min, | | 30 min, |
| | RT | 60° C. | RT | 60° C. | RT | 60° C. | RT | 60° C. |
| Cupping | Not testable | 3.5 | 7.5 | 7.0 | 6.5 | 6.0 | 8.5 | 8.0 |
| (EN ISO 1520) [mm] | owing to | | | | | | | |
| Pendulum hardness | crystalline | | | | | | | |
| (Koenig) [s] | covering | | | | | | | |
| after 1 d | on the | 31 | 10 | 13 | 8 | 11 | 6 | 8 |
| after 2 d | surface | 49 | 18 | 34 | 87 | 109 | 46 | 56 |
| after 7 d | | 87 | 66 | 97 | 106 | 127 | 71 | 85 |
| Ball impact [in lbs] | — | 60 | >80 | >80 | 40 | 60 | >80 | >80 |
| (DIN-EN-ISO 6272-1) | | | | | | | | |
| MEK test [ASTM D | — | >150 | >150 | >150 | >150 | >150 | 75 | 90 |
| 4752] (double rubs, | | | | | | | | |
| 1 kg applied weight) | | | | | | | | |

Numerous modifications and variations on the present invention are possible in light of the above description. It is therefore understood that within the scope of the appended claims, the invention may be practiced otherwise than as specifically described herein.

1. An adduct composition, comprising:
an adduct obtained by reaction of a compound of formula (I):
OCN-(Alkyl)-Si(Alkoxy)₃ (I)
with compounds of the formula (II):
HO—(R)—OH (II)
wherein
(Alkyl) is a linear or branched alkylene chain having 1-4 carbon atoms,
(Alkoxy) each independently is a methoxy, an ethoxy, a propoxy or abutoxy group, and
R is a branched alkylene or cycloalkylene radical having not more than 20 carbon atoms, optionally substituted with one or more hydroxy-groups.

2. The adduct composition according to claim 1, wherein the adduct obtained by reaction of a compound of formula (I):
OCN-(Alkyl)-Si(Alkoxy)₃ (I)
with compounds of the formula (II):
HO—(R)—OH (II)
is a liquid at a temperature greater than 0° C.

3. The adduct composition according to claim 1 wherein in the reaction to obtain the adduct, a ratio of OH groups of compound (II) to NCO groups of compound (I) is from 0.8:1 to 1.2:1.

4. The adduct composition according to claim 1, wherein the compound of formula (I) comprises at least one compound selected from the group consisting of 3-isocyanatopropyltrimethoxysilane, 3-isocyanatopropyltriethoxysilane, 3-isocyanatopropyltriisopropoxysilane, 2-isocyanatoethyltrimethoxysilane, 2-isocyanatoethyltriethoxysilane, 2-isocyanatoethyltriisopropoxysilane, 4-isocyanatobutyltrimethoxysilane, 4-isocyanatobutyltriethoxysilane, 4-isocyanatobutyltriisopropoxysilane, isocyanatomethyltrimethoxysilane, isocyanatomethyltriethoxysilane and isocyanatomethylriisopropoxysilane.

5. The adduct composition according to claim 1, wherein the compound of formula (II) is at least one compound selected from the group consisting of 2,2,4-trimethylhexane-1,6-diol, 2,4,4-trimethylhexane-1,6-diol, 2,2-dimethylbutane-1,3-diol, 2-methylpentane-2,4-diol, 3-methylpentane-2,4-diol, 2,2,4-trimethylpentane-1,3-diol, 2-ethylhexane-1,3-diol, 2,2-dimethylhexane-1,3-diol, 3-methylpentane-1,5-diol, 2-methylpentane-1,5-diol, 2,2-dimethylpropane-1,3-diol (neopentyl glycol), neopentyl glycol hydroxypivalate, 1,1,1-trimethylolpropane, 3(4),8(9)-bis(hydroxymethyl)-tricyclo[5.2.1.02,6]decane (Dicidol) and 2,2-bis(4-hydroxycyclohexyl)propane.

6. A coating composition comprising the adduct composition according to claim 1.

7. The coating composition according to claim 6, further comprising:
B) one or more binder components,
C) optionally, a catalyst,
D) optionally, an auxiliary or additive, and
E) optionally an organic solvent.

8. The coating composition according to claim 7, wherein the coating composition comprises a catalyst and a content of the catalyst is up to 4% by weight of the composition.

9. The coating composition according to claim 7, wherein a curing temperature of the composition is from 20 to 100° C.

10. The coating composition according to claim 7, wherein component B) comprises one selected from the group consisting of a hydroxyl-containing polyester, a hydroxyl-containing polyether, a hydroxyl-containing polyacrylate, a hydroxyl-containing polycarbonate and a hydroxyl-containing polyurethane.

11. The coating composition according to claim 10, wherein an OH number of the component B) is from 20 to 500 mg KOH/g and an average molar mass of the component B) is from 250 to 6000 g/mol.

12. The coating composition according to claim 8, wherein the catalyst C) comprises at least one of an organic carboxylic acid C1) having a melting point greater than 60° C. and a tetraalkylammonium carboxylate C2).

13. The coating composition according to claim 12, wherein the coating composition comprises a tetraalkylammonium carboxylate C2) which is selected from the group consisting of tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate.

14. A coated substrate comprising a cured coating of the coating composition according to claim 6 on a substrate, wherein the substrate is one selected from the group consisting of metal, plastic, glass and wood.

15. The coating composition according to claim 7, wherein a clearcoat coating is obtained by application and curing of the coating composition.

16. The coated substrate according to claim 14, wherein the curing coating is a clearcoat.
